(19) United States
(12) Patent Application Publication
(10) Pub. No.: US 2007/0160229 A1
(43) Pub. Date: Jul. 12, 2007

(54) Noise Filtering Edge Detectors

(76) Inventor: John Bogdan, Ottawa (CA)

Correspondence Address: John Bogdan, 1210 Major St., Ottawa, ON K2C 2S2, CA

(21) Appl. No.: 10/597,043

(22) PCT Filed: Jan. 7, 2005
(86) PCT No.: PCT/CA05/00017

§ 371 Date: Jul. 10, 2006

(30) Foreign Application Priority Data
Jan. 7, 2004 (CA) 2453292

(51) Int. Cl. H04B 15/00

(52) U.S. Cl. 381/94.1

(57) ABSTRACT

This invention relates to a noise filtering edge detector (NFED) for recovering data carrying edges from a noisy received signal by dense over-sampling of the received signal and by detecting edge phases and edge amplitude limits wherein recovered signal amplitudes at sampling instance defining said edge phase are determined by said edge amplitude limits while recovered amplitudes assumed at sampling instances following the last edge detected are those implementing an ideal signal shape determined by the last edge. The NFED comprises a system for adaptive noise filtering which analyzes captured unfiltered portions of the over-sampled waveform in order to compensate predictable and/or random signal distortions and interferences.

This application is a Continuation In Part of the U.S. application Ser. No. 10/520,040 following PCT/CA2003/000909 published as WO2004/002052 on 31 Dec. 2004 (one week before the priority date).

### BACKGROUND OF THE INVENTION

1. Field of the Invention

The parent application PCT/CA03/000909 describes the DSP MSP invention, which includes noise filters for digital filtering of a captured waveform. Such noise filters are shown; in the parent application's Sec.3 of DESCRIPTION OF THE PREFERRED EMBODIMENT, and in this application GENERAL DESCRIPTION OF INVENTION COMPONENTS which repeats the Sec.2 of the SUMMARY OF THE INVENTION of the parent application.

This invention defines much more efficient noise filters utilizing the method specified in the title as noise filtering edge detection which offers fundamental advantages over prior art filters using the method of noise filtering amplitude detection (see the section 2). Therefore this invention represents further development of circuits and methods described in the parent application PCT/CA03/000909.

This invention defines digital means for programmable noise filtering from over-sampled wave-forms consisting of variable lengths pulses having frequencies ranging from zero to ½ of technology's maximum clock frequency.

The noise filtering edge detectors (NFED) are directed to signal and data recovery in wireless, optical, or wireline transmission systems and measurement systems.

The noise filtering edge detectors (NFED) shall be particularly advantageous in system on chip (SOC) implementations of signal processing systems.

2. Background Art

Previous art noise filters calculate all output signal amplitudes corresponding to all digital sampling (or analog sensing) instances of input signals, in order to produce filtered output signals.

Since prior art filters spent their signal sampling (or sensing) resources and signal processing resources on calculating all reconstructed signal amplitudes, prior art filters for serial links shall be named as amplitude noise filters.

Such amplitude filtering approach originated from AM domination in early communication era. It was appropriate one for data transmissions methods which use signal amplitudes as the main means for encoding transmitted data.

However; contemporary communication methods are based on FM, PM, or NRZ/PAM over copper/fiber which use signal transitions between limited set of discrete levels and transitions phases as the means for data encoding.

All digitally transmitted data can be recovered entirely when such signal transmitting transitions and their phases are known. Since all original signal amplitudes between two transitions shall be expected to be equal to the final level reached by the last transition, there is no need to calculate filtered signal amplitude for every time instance occurring between transitions.

While prior art frequency domain signal processing is insufficient for identifying phase transients, prior art time domain signal processing requires by one order higher sampling rates and by several orders greater processing resources which cause it to be unaffordable for high speed data links.

Furthermore, prior art uses frequency domain filters for recovering data from serially transmitted pulses. Since serially transmitted pulses must have widely variable lengths and frequencies, such frequency domain filters have to attenuate significant useful part of such signal in order to eliminate high frequency phase jitter and high frequency amplitude glitches from such data carrying signal.

The above limitations of prior art amplitude noise filters are alleviated by this invention's noise filtering edge detectors (NFEDs); which use new time domain methods focused entirely on improving recovery of signal transients relevant to transmitted data, while avoiding said spending resources on calculations of predictable intermediate amplitudes.

All prior art filters used in serial link receivers for optical/wireline/wireless communication, process received unfiltered signal in order to detect noise filtered amplitudes which construct an amplitude recovering signal.

Such prior art filters are further named noise filtering amplitude detectors, in order to differentiate them from this inventions noise filtering edge detectors.

Said data carrying signal edges could be defined using their phases (i.e. time positions versus other edges) and their final levels (such final level of an edge is a last signal level reached by that edge). Such definitions of signal edges would provide sufficient information; for direct data recovery, and/or for reconstruction of originally transmitted data signal (all the signal amplitudes between every 2 consecutive edges can be filled based on said final levels of these 2 edges).

Such observation includes optical Non-Return-to-Zero (NRZ) systems and ethernet PAM systems, involving discrete digitized phase modulations defining length of every signal pulse wherein such lengths determines number of data symbols carried between pulse edges. Said PAM systems comply with such observation as well since they include much greater ranges of phase modulations than their amplitude modulations limited to several discrete levels only.

The other observation is that;

Since transmitted data are carried by signal edges said amplitude recovering signal produced by prior art filters is merely an intermediate signal which has to be processed further by an edge sensing circuit in order to recover information carried by signal edges which is necessary for actual data recovery.

Consequently; prior art receivers suffer from 2 inherent sources of errors, explained below:
1. Significant part of information needed for recovering signal edges has to be lost during the noise filtering amplitude detection, since the noise filtering amplitude detectors are unable to minimize edge phase noise as they have to minimize amplitude noise instead.
2. Since the amplitude recovering signal still has some amplitude noise in it and prior art edge sensing circuits can not provide any effective noise filtering, resulting prior art edge sensing introduces still more errors during said recovery of data carried by signal edges.

The NFED invention uses fundamentally superior principle of operation, since NFED processes received unfiltered signal directly by using highly effective phase noise filtering for a direct recovery of filtered edges carrying received data.

Since such NFED eliminates said inherent errors of prior art and accomplishes immediate much more accurate detection of noise filtered edges it shall increase lengths of optical/wireline/wireless links by 2 times by enabling by several times better SNR tolerances.

Yet another major NFED contribution over prior art is achieved by its signal processing circuits, which enable 10 times faster time domain processing by combining 10 times higher sampling frequencies with 10 times greater processing throughput.

Maximum frequency of waveforms which can be processed by prior art circuits might reach up to ½ of technology's maximum clock frequency if frequency domain processing is used.

However since time domain processing usually requires 10 times higher sampling frequency and 10 times greater processing throughput as well maximum frequency of waveforms processed using prior art circuits has to be lower by ˜10 times and has to be limited to ˜ 1/20 of said maximum clock frequency if time domain processing is used.

Nevertheless since NFED signal processing circuits enable said 10 times faster sampling and 10 times faster processing, the NFED circuits (explained in the next sections) demonstrate unique ability to accomplish time domain processing of waveforms having frequencies reaching said limit of ½ of said maximum clock frequency.

The parent invention (U.S. Ser. No. 10/520,040) allocates generic processing stages for noise filtering while designating close control and significant parts of noise filtering functions to be performed by a Programmable Control Unit (PCU).

However the present invention provides definitions of much more efficient noise filtering functions and specifies more efficient hardware means for said functions implementation than that enabled by U.S. Ser. No. 10/520,040.

### SUMMARY OF THE INVENTION

The NFED invention provides an implementation of programmable algorithms for noise filtering for a very wide range of low and high frequency wave-forms.

The NFED comprises; use of a synchronous sequential processor (SSP) for real time capturing and processing of in-coming wave-form, and use of a programmable computing unit (PCU) for controlling SSP operations and supporting adaptive noise filtering and edge detection algorithms (see the GENERAL DESCRIPTION OF INVENTION COMPONENTS).

The NFED comprises using a set of binary values as an edge mask which is compared with a set of captured binary values surrounding a bit of a captured waveform buffer, in order to check if the captured bit represents an edge of the waveform.

Said comparison comprises:
performing logical and/or arithmetic operations on particular bits of the edge mask and their counterparts from the waveform samples surrounding the particular bit of the waveform buffer;
performing arithmetic and/or logical operations on the results of said operations, in order to estimate waveform's edge proximity figure (EPF);
comparing the EPF with an edge threshold, in order to determine if the captured bit represents an edge of the waveform.

The NFED further comprises modulating placement of detected rising and/or falling waveform edges by an edge modulating factor (EMF) calculated as a function of the EPF, were said function is controlled by an edge modulation control register (EMCR) which is preset by an external control unit.

The NFED still further comprises displacing detected rising and/or falling waveform edges by a preset number of bits, in order to compensate for Inter-Symbol-Interference (ISI) and/or other duty cycle distortions.

The NFED invention further includes:
using the WFSC for incoming waveform registration and monitoring (see the GENERAL DESCRIPTION OF INVENTION COMPONENTS);
programmable waveform analysis and adaptive noise filtering algorithms;
edge mask registers for providing said edge masks used for detecting rising and/or falling waveform edges;
edge threshold registers for providing said edge thresholds used for detecting rising and/or falling waveform edges;
edge displacement registers for providing said edge displacement numbers used for shifting detected rising and/or falling edges by a programmable number of bits of waveform processing registers;
filter control registers which control; said logical and/or arithmetic operations conducting the comparison of captured waveform bits with the edge mask, and said edge displacements in the processed waveforms;
using the PCU for calculating and loading said edge mask registers and/or said edge threshold registers and/or said edge displacement registers and/or said filter control registers;
using the PCU for controlling said calculations of the EMF by presetting the EMCR in accordance with adaptive noise filtering algorithms.
using the PCU for controlling and using the WFSC operations for implementing adaptive filters by controlling noise filtering edge detection stages of the SSP.
   Such NFED Comprises Methods, Systems and Circuits Described Below.
1. A noise filtering edge detector (NFED) for removing phase noise from wave-form edges and/or removing amplitude glitches from wave-form pulses by continues digital filtering of the entire incoming wave-form sampled in time instances matching single gate delays provided by outputs of a delay line built with serially connected gates which a sampling clock is propagated through, wherein variable lengths pulses having frequencies ranging from zero to ½ of technology's maximum clock frequency are processed by comparing an edge mask, which provides an expected pattern of wave-form samples corresponding to an edge of the wave-form, with a sequence of wave-form samples surrounding a consecutive analyzed sample; the NFED comprising:
a wave capturing circuit for capturing results of sampling the incoming wave-form in time instances produced by the outputs of the delay line which the sampling clock is propagated through;
an apparatus for performing logical or arithmetic operations on particular samples of the edge mask and their counterparts from the wave-form samples surrounding the consecutive analyzed sample of the captured wave-form;
an apparatus for using the results of said operations for deciding if said operations can determine a filtered location of an edge of a filtered wave-form.
2. An NFED as described in statement 1, wherein said edge mask samples of the expected edge pattern are compared with samples from a consecutive processed region of the captured wave-form wherein correlation between a consecutive edge mask sample and a corresponding sample from the processed region is estimated by performing an arithmetical or logical operation on said consecutive mask sample and on said corresponding sample from the processed region; the NFED comprising:
a circuit for accessing any said consecutive processed region of the captured wave-form and using such region as comprising samples corresponding to the edge mask samples;
a circuit for selection of a consecutive sample from the edge mask and for simultaneous selection of a corresponding consecutive sample from the processed region of the captured wave-form;
a circuit for calculating a correlation component between such selected samples by performing an arithmetical or logical operation on said selected samples;
a circuit for calculating a digital correlation integral by adding said correlation components calculated for single samples of the edge mask.
3. An NFED as statement 2, wherein said correlation integrals are calculated for said consecutive processed regions uniformly spread over all the captured wave-form wherein said calculated correlation integrals are further analyzed and locations of their maximums or minimums are used to produce said filtered locations of said edges of the filtered wave-form; the NFED comprising:
a circuit for moving said processed region by a programmable number of samples positions of the captured wave-form;
a circuit for storing and comparison of said correlation integrals calculated for different processed regions, in order to identify said maximums or minimums and their locations;
a circuit for using said locations of said maximums or minimums for producing the filtered locations of the edges of the filtered wave-from.
4. An NFED as described in statement 3, wherein noise is filtered and said storing and comparison of said correlation integrals are simplified by subtracting an edge threshold from any newly calculated correlation integral first and by disregarding all resulting decreased integrals if they are negative while using only positive decreased integrals for further noise filtering; the NFED further comprising:
a circuit for subtracting the edge threshold from any newly calculated correlation integral, in order to determine if such decreased integral indicates signal change greater than noise levels and to reduce amount of further processing;
an apparatus for dismissing those said decreased integrals which have negative values, and for classifying only those said decreased integrals which are still positive for a further signal processing including said comparisons.
5. An NFED as described in statement 1, wherein the NFED further comprises:
a filter arithmometer for comparing the edge mask with the captured wave-form in order to introduce noise filtering corrections of the edges of the filtered wave-form;
a filter mask register providing the edge mask which is compared with the captured wave-form of an input signal and/or filter control register which provides code for controlling operations of said filter arithmometer in order to provide said corrections of the filtered wave-form.
6. A noise filtering edge detector (NFED) as described in statement 1, wherein the NFED includes compensation of inter-symbol interference (ISI) or other predictable noise by adding a programmable displacement to said filtered location of the edge of the wave-form; the NFED comprising:
a circuit for programmable amendment of the filtered location of the wave-form edge by presetting said programmable displacement with a new content;
a circuit for using such newly preset displacement for shifting the filtered location of the next detected edge.
7. A noise filtering edge detector (NFED) as described in statement 1, wherein the NFED uses a set of binary values as the edge mask which is compared with a set of captured binary values surrounding the analyzed sample of the captured wave-form in order to produce an edge proximity figure (EPF) estimating a proximity of the analyzed sample to a nearest wave-form edge wherein the EPF is further compared with an edge threshold in order to detect if the analyzed sample can point out location of an edge of the filtered wave-form; the NFED comprising:
a circuit for using the results of said operations for producing the edge proximity figure (EPF) estimating a mismatch between said nearest edge and the wave-form region surrounding the analyzed sample;
a circuit for comparing the EPF with the edge threshold, in order to determine if the analyzed sample provides said location of an edge of the filtered wave-form.
8. A noise filtering edge detector (NFED) as described in statement 7, wherein the NFED further includes compensation of periodical predictable noise with programmable modulations of said filtered locations of the wave-form edges by using an edge modulating factor (EMF) for a periodical diversification of said edge thresholds corresponding to different said regions of the wave-form; the NFED comprising:
a circuit for modulation of the filtered locations of the wave-form edges by using the edge modulating factor (EMF) for modulating said edge thresholds which are used for the evaluation of the EPF's calculated for said different wave-form regions surrounding different consecutive samples of the captured wave-form;
whereby said EMF provides such modulation of the edge thresholds, that predictable noise introduced to consecutive wave-form samples by known external or internal sources, is compensated.
9. A noise filtering edge detector (NFED) as described in statement 8, wherein:
said modulation of the edge thresholds is controlled by an edge modulation control register (EMCR) which is preset by an external control unit.
10. An NFED as described in statement 1, wherein the NFED comprises:
sequential processing stages configured into a sequential synchronous pipeline driven synchronously with said sampling clock.
11. An NFED as described in statement 10, further comprising parallel processing phases implemented with said synchronous sequential pipelines; wherein:
said parallel processing phases are driven by clocks having two or more times lower frequencies than said sampling clock;
consecutive parallel phases are driven by clocks which are shifted in time by one or more periods of said sampling clock;
12. An NFED as described in statement 11, wherein:
said wave-form filtering is extended beyond a boundary of a single phase by using multiple noise filtering sequential stages in every parallel processing phase.
13. An NFED as described in statement 12, including an over-sampled capturing of consecutive wave-form phases in corresponding phases wave registers which are further rewritten to wave buffers with overlaps which are sufficient for providing all wave samples needed for a uniform filtering of any edge detection despite crossing boundaries of the wave buffers which are loaded and used during different said phases; the NFED comprising:
a circuit for rewriting the entire wave register belonging to one phase into the wave buffer of the same phase and for rewriting an end part of said wave register into a front part of the next phase wave buffer, while the remaining part of the next wave buffer is loaded from the wave register belonging to the next phase;
whereby every wave buffer contains entire said wave-form regions needed for calculating said EPF's corresponding to the samples belonging to the phase covered by this buffer.
14. An NFED as described in statement 12, wherein:
carry over bit or bits of an output register of a first filter stage of one phase is or are clocked-in into an output register of the first filter stage of a next phase together with filtering results of the next phase;
a second filter stage of the next phase uses the output register of the first filter stage for filtering a wave-form interval which extends into the next phase.
15. An NFED as described in statement 12, comprising:
a circuit for merging of said parallel processing phases, wherein multiple said parallel processing phases are merged into a smaller number of parallel phases or into a single processing phase, when passing from one said sequential processing stage to the next sequential stage.
16. An NFED as described in statement 12, comprising:
a circuit for splitting of said parallel processing phases, wherein one said processing phase is split into multiple parallel processing phases or multiple parallel processing phases are split into even more parallel phases, when passing from one said sequential processing stage to the next sequential stage.
17. An NFED as described in statement 12, further including a programmable control unit (PCU) for reading results of captured signal processing from the NFED and for controlling operations of the NFED; wherein the PCU comprises:
a circuit for reading results of captured signal processing from the NFED;
an apparatus for programming the filter mask register and/or the filter control register and/or said presetting of the programmable displacement and/or the edge modulating factor, which are applied for achieving said filtering of the captured wave-forms.
18. An NFED as described in statement 1, further including a programmable control unit (PCU) for reading results of captured signal processing and for controlling operations of said signal processing
19. An NFED as described in statement 1, further including a wave-form screening and capturing circuit (WFSC) for incoming waveform registration and monitoring wherein the WFSC identifies characteristics of the incoming wave-form captured with the resolution matching single gate delays; wherein the WFSC comprises:
a circuit for using programmable screening masks and/or programmable control codes for verifying incoming wave-form captures for compliance with said programmable screening masks.
20. An NFED as described in statement 19, wherein the WFSC comprises:
a circuit for buffering captured wave-form for which the pre-programmed compliance or non-compliance has been detected, or for counting a number of said detections;
a circuit for communicating said buffered wave-form and/or a detections counter, to an internal control circuit and/or to an external unit.
21. An NFED as described in statement 20 further including a programmable control unit (PCU) for reading results of captured signal processing from the WFSC and for controlling operations of the WFSC; wherein the PCU comprises:
a circuit for programming the screening masks and/or the control codes for performing said verification of captured wave-forms compliance or non-compliance with said screening patterns;
a circuit for reading verification results and/or reading captured wave-forms which correspond to the preprogrammed verification criteria.
22. An NFED as described in statement 21 including implementation of adaptive noise filtering algorithms; wherein the PCU comprises:
means for programmable waveform analysis;
a circuit for loading edge mask registers which provide said edge masks used for detecting rising and/or falling wave-form edges;
or a circuit for loading edge threshold registers which provide said edge thresholds used for detecting rising and/or falling waveform edges;
or a circuit for loading edge displacement registers which provide said edge displacements used for shifting detected rising and/or falling edges by a programmable number of samples positions of the captured wave-form;
or a circuit for loading filter control registers which control said logical and/or arithmetic operations conducting the comparison of captured wave-form samples with the edge mask, and said edge displacements in the processed wave-forms;
or an apparatus for controlling said EMF by presetting the EMCR in accordance with adaptive noise filtering algorithms.

### GENERAL DESCRIPTION OF INVENTION COMPONENTS

The DSP MSP invention (originated in the parent PCT/CA03/000909) provides an implementation of programmable algorithms for analyzing a very wide range of low and high frequency wave-forms.

The DSP MSP comprises a synchronous sequential processor (SSP) for real time capturing and processing of in-coming wave-form and a programmable computing unit (PCU) for controlling SSP operations and supporting adaptive signal analysis algorithms.

Said SSP invention comprises a multisampled phase (MSP) capturing of incoming wave-form level by a locally generated sampling clock and its sub-clocks generated by the outputs of serially connected gates which the sampling clock is propagated through. If an active edge of the wave-form is detected by capturing a change in a wave-form level, the position of the captured signal change represents an edge skew between the wave-form edge and an edge of the sampling clock.

In addition to the above wave-form capturing method, the SSP includes 3 other methods of the edge skew capturing which are defined below:
the sampling clock captures the outputs of serially connected gates which the incoming wave-form is propagated through;
the outputs of serially connected gates which the incoming wave-form is propagated through, provide wave-form sub-clocks which capture the sampling clock.
the incoming wave-form captures the outputs of serially connected gates which the sampling clock is propagated through;

The above mentioned edge skew capturing methods further include:
using falling edges of said sub-clocks for driving clock selectors which select parallel processing phases during which positive sub-clocks are enabled to perform said edge skew capturing, or using rising edges of said sub-clocks for driving selectors which select parallel processing phases during which negative sub-clocks are enabled to perform said edge skew capturing;
using serially connected clock selectors for enabling consecutive sub-clocks, in order to assure that consecutive sub-clocks will target appropriate consecutive bits of appropriate capture registers.

The SSP invention includes using said serially connected gates:
as being an open ended delay line;
or being connected into a ring oscillator which can be controlled in a PLL configuration;
or being connected into a delay line which can be controlled in a delay locked loop (DLL) configuration.

Every said edge skew amounts to a fraction of a sampling clock period.

The SSP invention comprises measuring time intervals between active wave form edges, as being composed of said edge skew of a front edge of the incoming waveform, an integer number of sampling clock periods between the front edge and an end edge, and said edge skew of the end edge of the wave-form.

The SSP invention further comprises a parallel multiphase processing of incoming signal by assigning consecutive parallel phases for the capturing of edge skews and/or processing of other incoming wave-form data with clocks which correspond to consecutive sampling clocks.

Consequently the SSP invention comprises using 1 to N parallel phases which are assigned for processing incoming signal data with clocks corresponding to sampling clock periods number 1 to N, as it is further described below:
circuits of phase1 process edge skews or phase skews or other incoming signal data with a clock which corresponds to the sampling clock period number 1;
circuits of phase2 process edge skews or phase skews or other incoming signal data with a clock which corresponds to the sampling clock period number 2;
finally circuits of phaseN process edge skews or phase skews or other incoming signal data with a clock which corresponds to the sampling clock period number N.

Said parallel multiphase processing allows N times longer capturing and/or processing times for said multiphase stages, compared with a single phase solution.

The SSP invention includes parallel stage processing of incoming signal by providing multiple processing stages which are driven by the same clock which is applied simultaneously to inputs of output registers of all the parallel stages.

The SSP further comprises a synchronous sequential processing of incoming signal by using multiple serially connected processing stages with every stage being fed by data from the previous stage which are clocked-in by a clock which is synchronous with the sampling clock.

Since every consecutive stage is driven by a clock which is synchronous to the same sampling clock, all the stages are driven by clocks which are mutually synchronous but may have some constant phase displacements versus each other.

The SSP further comprises:
merging of processing phases which occurs if multiple parallel processing phases are merged into a smaller number of parallel phases or into a single processing phase, when passing from a one processing stage to a next processing stage;
splitting of processing phases which occurs if one processing phase is split into multiple processing phases or multiple processing stages are split into even more processing stages, when passing from a one processing stage to a next processing stage.

The SSP invention includes a sequential clock generation (SCG) circuit which uses said clock selectors and said sub-clocks: to generate SSP clocks which drive said parallel phases and said sequential stages, and to generate selector switching signals for said merging and splitting of processing phases.

The SSP invention includes time sharing of said parallel phases: which is based on assigning a task of processing of a newly began wave-form pulse to a next available parallel processing phase.

The SSP comprises a sequential phase control (SPC) circuit which uses results of a wave edge decoding and said SSP clocks, for performing said time sharing phase assignments and for further control of operations of an already assigned phase.

The SSP comprises passing outputs of a one parallel phase to a next parallel phase, in order to use said passed outputs for processing conducted by a following stage of the next parallel phase.

The outputs passing is performed: by re-timing output register bits of the one phase by clocking them into an output register of the next parallel phase simultaneously with processing results of the next parallel phase.

The SSP further comprises all the possible combinations of the above defined: parallel multiphase processing, parallel stage processing synchronous sequential processing, merging of processing phases, splitting of processing phases and outputs passing.

The SSP invention includes processing stage configurations using selectors, arithmometers, and output registers, which are arranged as it is defined below:
input selectors select constant values or outputs of previous stages or outputs of parallel stages or an output of the same stage to provide arithmometer inputs, and arithmometer output is clocked-in to an output register by a clock which is synchronous to the sampling clock;
multiple arithmometers are fed with constant values or outputs of previous stages or outputs of parallel stages or an output of the same stage, and an output selector selects an arithmometer output to be clocked-in to an output register by a clock synchronous to the sampling clock;
the above defined configuration as being supplemented by using an output of an output selector of a parallel processing stage for controlling output selector functions.

Proper arrangements of said parallel and sequential combinations and said stages configurations provide real time processing capabilities for very wide ranges of signal frequencies and enable a wide coverage of very diversified application areas.

The DSP MSP invention comprises two different methods for accommodating a phase skew between the sampling clock and a clock which drives the incoming wave-form, and both methods allow elimination of ambiguities and errors in decoding incoming signal data patterns. Said two methods are further defined below:
a clock synthesizer is used for producing the sampling clock, which will maintain frequency or phase alignment with the clock which drives the incoming wave-form;
expected phase skews between the sampling clock and the wave-form driving clock are calculated and used to correct measurements and data patterns decoding of the incoming signal pulses;
both above mentioned methods include measurements of phase or frequency deviations of the incoming signal clock versus the sampling clock, and using said measurements results to control the clock synthesizer or to calculate the expected phase skews.

The DSP MSP invention comprises a fractional bit staffing (FBS) which improves accuracy of fixed point arithmetic far beyond of what conventional solutions could offer.

The FBS uses processing arguments which are expressed as a series of terms, where each term may have a differently staffed last bit or several last bits. Said differently staffed last bits express a fractional value which is combined with previous bits which express a constant more significant part of a processing argument.

The DSP MSP cumulative processing operations are split into a series of basic addition or subtraction or comparison operations. Every said consecutive term, of a processing argument of a cumulative operation, is used for processing performed during a corresponding consecutive basic operation.

Consequently using the FBS enables reducing of a total error of a long cumulative processing operation to a single last bit resolution.

The DSP MSP invention comprises: using phase differences between incoming signal pulses identified with the MSP captures and expected data patterns defined by sampling clock periods, for processing of the incoming signal and for detecting data patterns delivered by incoming signal pulses.

The DSP MSP invention further comprises more conventional method, which calculates whole time intervals of incoming signal pulses and divides them by time intervals of expected data patterns which would be defined in sampling clock periods.

It shall be noted however: that said use of the phase differences, which are small fractions of the whole intervals, allows significant reductions in processing time and in processing hardware.

The DSP MSP invention includes noise filters for digital filtering of a captured wave-form, which include the circuits listed below:
filter mask registers and filter control registers which can be downloaded from the PCU;
digital filter arithmometers which use the mask registers content for correcting captured wave-forms in accordance with control codes provided by said filter control registers;

Said noise filters further include adding a second noise filter stage in every noise filtering parallel phase for the purpose of extending a range of a filtered waveform beyond a boundary of a single phase.

Said second filter stages shall have the same basic circuits as the above mentioned first filter stages.

In order to allow said boundary extension, carry over bit or bits of an output register of said first filter stage of one phase shall be clocked-in into an output register of the first filter stage of a next phase together with filtering results of the next phase. Consequently the second filter stage of the next phase shall use the output register of the first stage for filtering a wave-form interval which extends through both said phases.

The DSP MSP invention includes phase processing stages (PPS), which can perform listed below operations:
calculating the front edge skew and the end edge skew of the in-coming wave-form pulses;
combining said edge skews with other indicators of pulse duration and phase deviations between the sampling clock and a clock which generates the incoming wave-form;
evaluating the resulting timing of the incoming wave-form pulses versus expected timing values which correspond to interpretation patterns of the incoming signal;
communicating results of the above mentioned operations to other circuits of the DSP MSP.

The DSP MSP invention includes periodical skew accumulation (PSA) circuits, which can perform listed below operations:
providing amounts of phase skew between the sampling clock period versus an expected period of a clock which drives the incoming signal;
providing said phase skews as being different for every individual sampling clock period;
reading the next set of said phase skews from external circuits, and seamless attaching them to a present set of the phase skews;
calculating accumulations of said phase skews for every pulse or for combinations of pulses of the incoming signal;
synchronous communicating of said accumulations of the pulse skews to the phase processing stages and/or to other parts of the DSP MSP.

The DSP MSP invention further includes received data collection (RDC) circuits for performing the operations, which are listed below:
using outputs of the PPS and the PSA circuits for detecting and registering incoming data patterns;
seamless combining of the registered data patterns into unified data blocks consisting of fixed number of bits or bytes;
seamless communicating of the unified data blocks to an internal control unit and/or to an external unit.

The DSP MSP invention comprises data frequency capturing (DFC) circuits, for providing listed below operations:
using outputs of MSP processing for detecting and registering time intervals of incoming signal pulses defined by the incoming signal clock;
using outputs of RDC circuits for detecting and registering time intervals of the data patterns defined by the sampling clock, which correspond to the above mentioned already registered time intervals of incoming signal pulses;
seamless combining of the pulses time intervals bounded with the corresponding data patterns intervals into frequency measurement blocks providing relation between a frequency of the incoming signal clock and a frequency of the sampling clock;
seamless communicating of the frequency measurement blocks to an internal control unit and/or to an external unit.

The DSP MSP invention comprises wave-form screening and capturing circuits (WFSC), for providing listed below operations:
using programmable data masks and programmable control codes for verifying incoming MSP captures for compliance or non-compliance with a pre-programmed screening patterns;
buffering captured data for which the pre-programmed compliance or non-compliance have been detected;
counting a number of the above mentioned detections;
communicating both the buffered captured data and the number of detections, to an internal control unit and/or to an external unit;
using programmable time slot selection circuits for selecting a time interval for which incoming MSP captures shall be buffered and communicated to an internal control unit and/or to an external unit.

Said PCU comprises implementation of the functions listed below:
programming of verification functions and patterns for checking captured wave-forms for compliance or non-compliance with the patterns;
reading verification results and reading captured wave-forms which correspond to the preprogrammed verification criteria;
reading captured wave-forms which can be pre-selected by the PCU arbitrarily and/or based on other inputs from the SSP;
programming of noise filtering functions and noise filtering masks for filtering captured wave-forms;
reading results of real-time wave-form processing from the SSP, processing the results and providing control codes and parameters for further real-time wave-form processing in the SSP, in accordance with adaptive signal processing algorithms;
reading output data from the SSP, interpreting the data, and communicating the data to external units.

The DSP MSP invention comprises said SDR MSP circuits, which further include listed below features:
multisampling of every individual bit of a received data stream;
detection and registration of a phase of every rising or falling edge of the received data stream;
filtering out received signal noise;
using lengths of a pulse of the incoming signal for calculating a number of data bits received in the pulse;
registration of the detected data bits and seamless communication of the received data to an internal control unit and/or to an external unit.

### DESCRIPTION OF THE PREFERRED EMBODIMENT

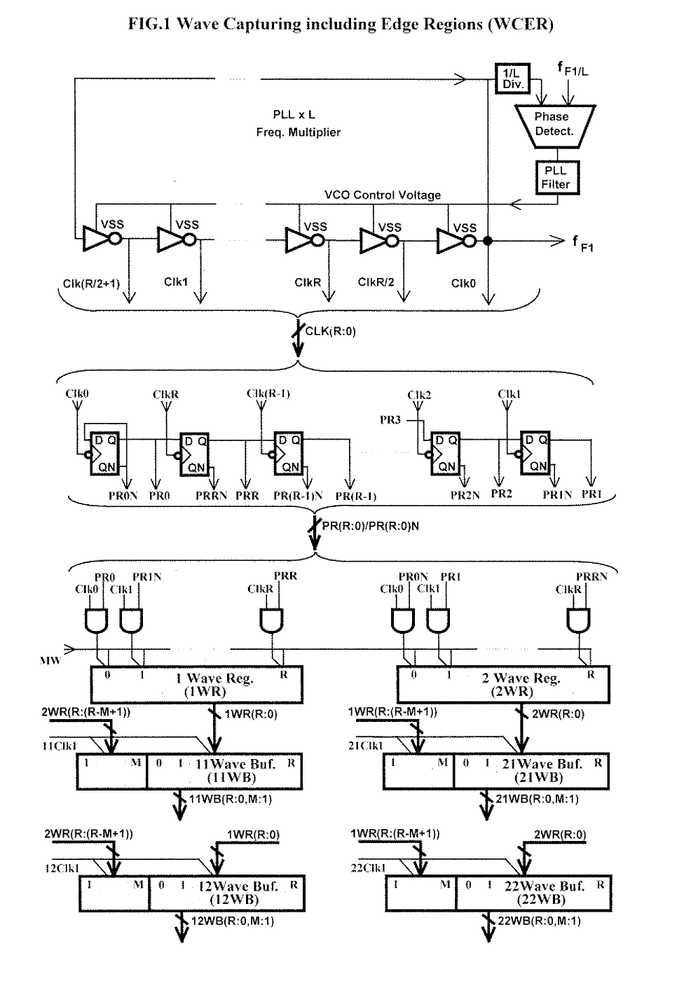

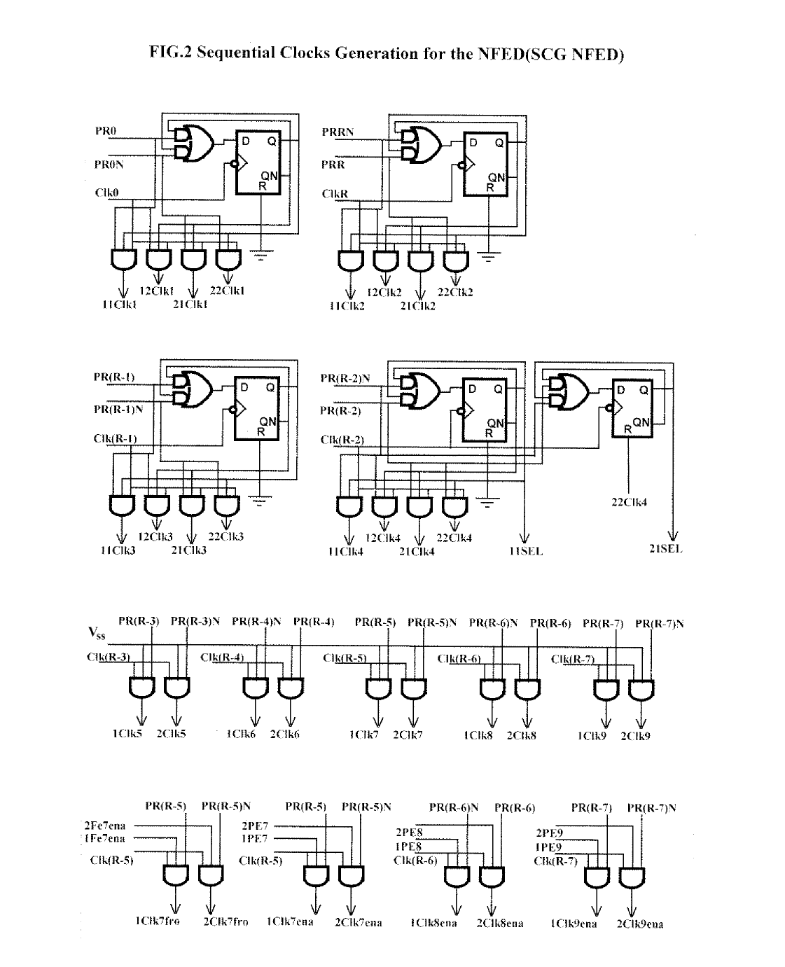

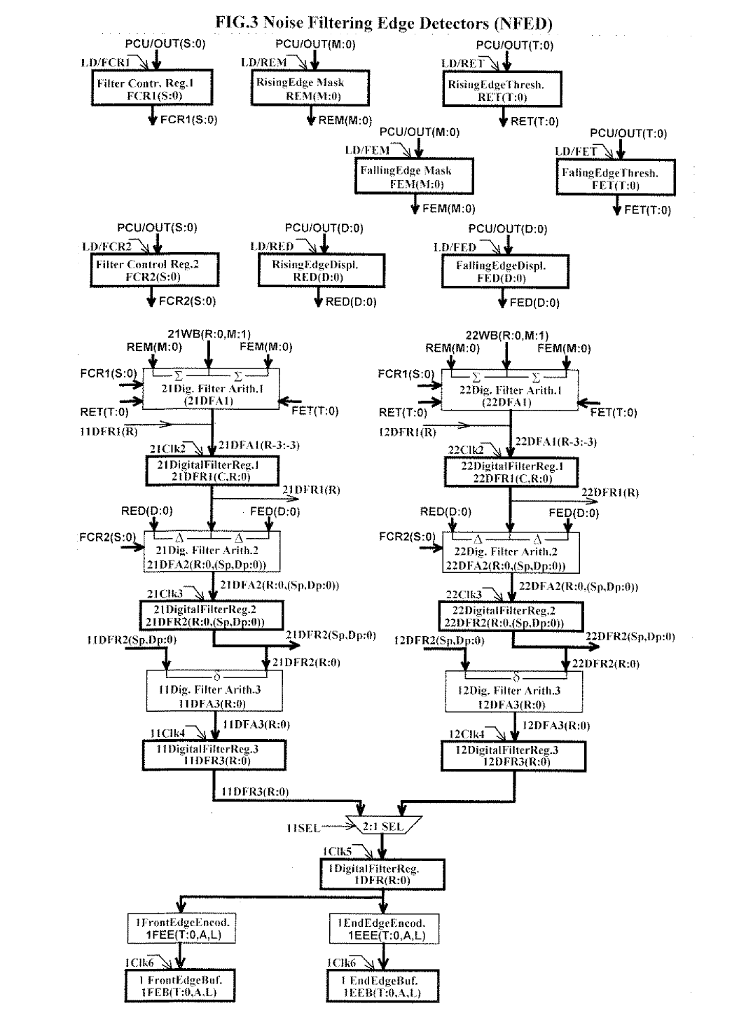

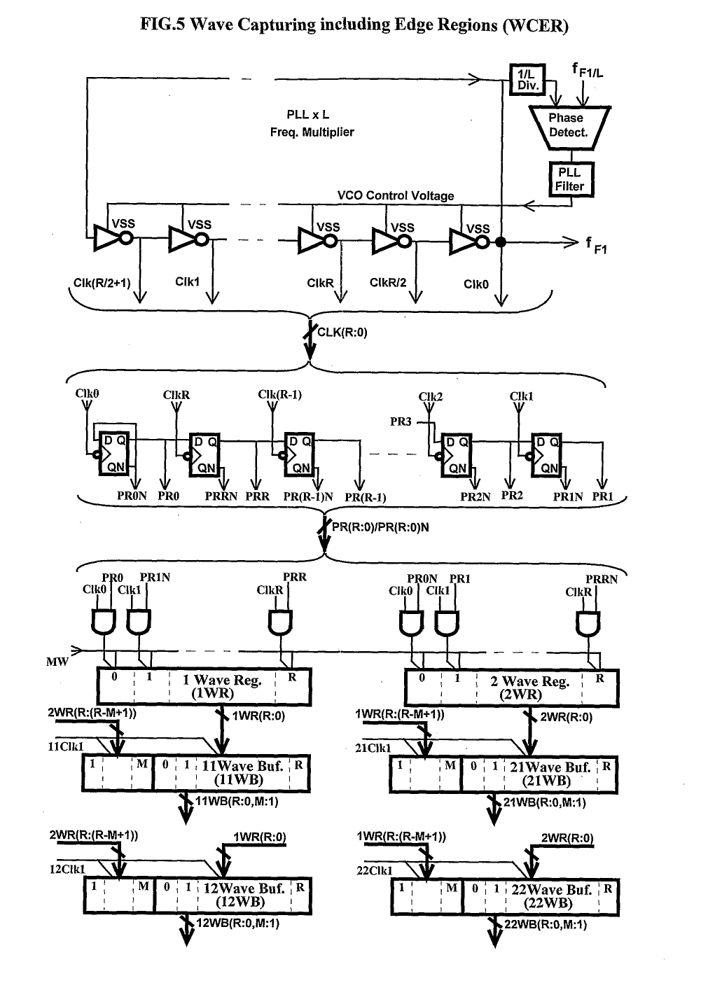

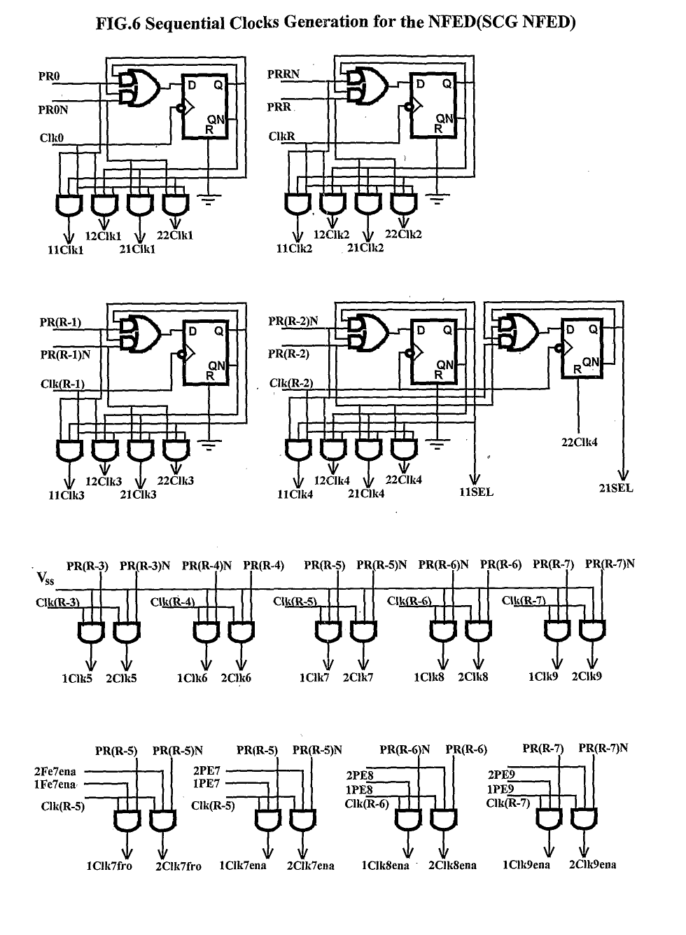

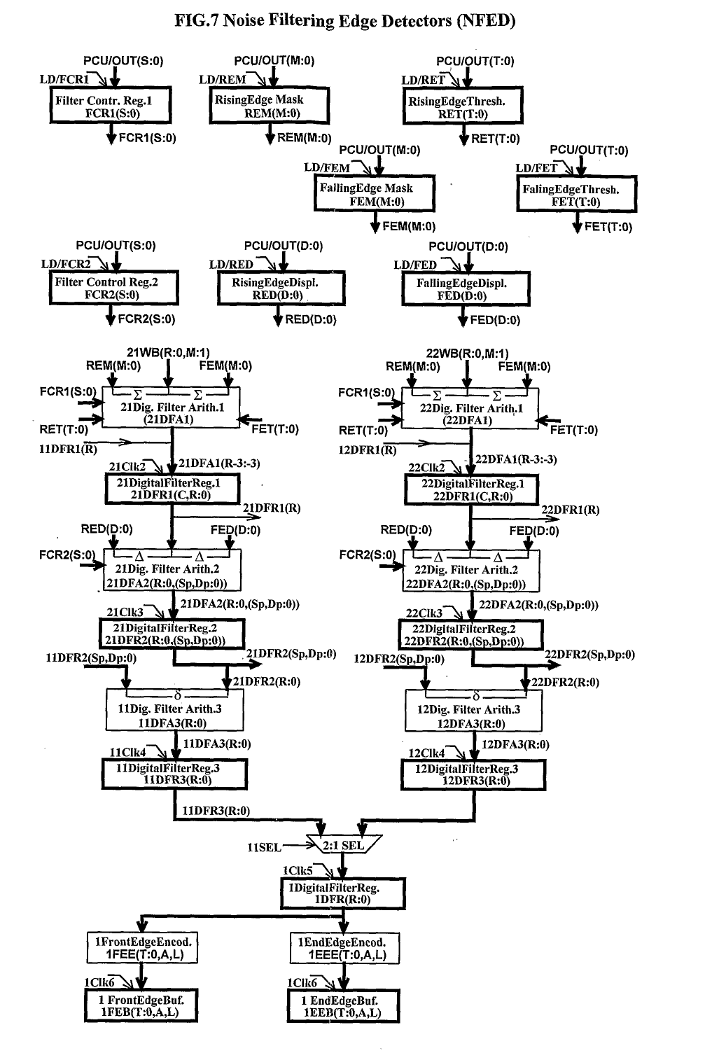

The preferred embodiment implements the above defined general components of the NFED and is shown in FIG.1, FIG.2 and FIG.3.

Said NFED comprises the multi-sampled phase (MSP) capturing of incoming wave-form intervals in specifically dedicated wave interval registers which are further rewritten to wave interval buffers (see the FIG. 1 showing the wave registers 1WR,2WR followed by the wave buffers 11WB, 12WB, 21WB, 22WB).

In order to provide all wave samples needed for the filtering edge detection along a whole wave buffer, the NFED invention includes rewriting:
the end part 2WR(R:(R−M+1) of the wave register 2WR, into the front parts 11WB (M:1),12WB(M:1) of the wave buffers 21WB,12WB;
the end part 1WR(R:(R−M+1) of the wave register 1WR, into the front parts 21WB (M:1),22WB(M:1) of the wave buffers 21WB,22WB.

The preferred embodiment is based on the assumptions listed below:
the wave registers 1WR and the 2WR are 15 bit registers (i.e. R=14);
the rising edge mask REM(M:0) and the falling edge mask FEM(M:0) are 8 bit registers (i.e. M=7) and the PCU loads the same masks equal to 00001111 to both mask registers;
the rising edge threshold RET is loaded with 0110 (6 decimal), and the falling edge threshold FET is loaded with 0010 (2 decimal);

The digital filter arithmometers 21DFA1/22DFA1/11DFA1/12DFA1 perform all the comparison functions, between the edge mask registers REM/FEM and the waveform buffers 21WB/22WB/11WB/12WB involving the edge threshold registers RET/FET, with the 3 basic operations which are further explained below.

The first operation is performed on all the waveform bits and involves the edge mask bits as it is specified below:

For every waveform's consecutive bit WBₖ the surrounding bits WBₖ₋₄, WBₖ₋₃, WBₖ₋₂, WBₖ₋₁, WBₖ, WBₖ₊₁, WBₖ₊₂, WBₖ₊₃ are logically compared with the mask bits B₀, B₁, B₂, B₃, B₄, B₅, B₆, B_{M} and the resulting 8 bit binary expression BEₖ(7:0) is created as equal to;
BEₖ(0)=(WBₖ₋₄=B₀), BEₖ(1)=(WB_{K-3}=B₁), BEₖ(2)=(WBₖ₋₂=B₂), BEₖ(3)=(WBₖ₋₁=B₃), BEₖ(4)=(WBₖ=B₄), BEₖ(5)=(WBₖ₊₁=B₅), BEₖ(6)=(WBₖ₊₂=B₆), BEₖ(7)=(WBₖ₊₃=B₇).

The second operation adds arithmetically all the bits of the binary expression BEₖ(7:0) and the resulting edge proximity figure EPFₖ is calculated as equal to EPFₖ=BEₖ(0)+BEₖ(1)+BEₖ(2)+BEₖ(3)+BEₖ(4)+BEₖ(5)+BEₖ(6)+BEₖ(7) which shall amount to a 0-8 decimal number.

The third operation performs functions explained below:
The verification is made if the EPFₖ indicates a rising edge condition by exceeding the content of the rising edge threshold RET(T:0). Consequent detection of the EPFₖ>RET=6 condition, sets to level=1 the corresponding DFR1ₖ bit of the DFR1 and all the remaining bits of the present DFR1 until a falling edge is detected as it explained below.
The verification is made if the EPFₖ indicates a falling edge condition by being smaller than the content of the falling edge threshold FET(T:0). Consequent detection of the EPFₖ<RET=2 condition, sets to level=0 the corresponding DFR1ₖ bit of the DFR1 and all the remaining bits of the present DFR1 unless a rising edge is detected as it explained above.

In order to carry the same level from the last bit of the previous phase DFR1 into the following bits of the present phase digital filter register2 (DFR2), the last bit DFR1(R) of the previous DFR1 is rewritten into the carry bit DFR1(C) of the present DFR1 and is used by the digital filter arithmometer2 (DFRA2) to fill front bits of the DFR2 with the same level as the last bit of the previous phase DFR1.

The digital filter arithmometers 21DFA2/22DFA2/11DFA2/12DFA2 perform; the inter-phase continuation of filling front bits of the present phase register in accordance with the level set in the last bit of the previous phase, followed by said edge displacement which compensates for duty cycle distortions due to ISIs, etc..

The edge displacement comprises the 3 basic operations described below.
Any DFR1 rising edge, indicated by a level 0 to 1 transition, is shifted left by a number of bits specified by a content of the rising edge displacement register (RED(D:0)) loaded by the PCU in accordance with its filtering algorithms.
Any DFR1 falling edge, indicated by a level 1 to 0 transition, is shifted left by a number of bits specified by a content of the falling edge displacement register (FED(D:0)) loaded by the PCU in accordance with its filtering algorithms.
In order to propagate said displacement operations from the present processing phase to the previous processing phase; the propagated sign of the edge bit (DFR2(Sp)) and the propagated bits (DFR2(Dp:0)), are calculated by the DFA2 and are written down into the DFR2 extension DFR2(Sp,Dp:0).

In order to propagate said displacement operations from the next phase DFR2 into end bits of the present phase digital filter register3 (DFR3); the propagated sign of the edge bit and the propagated displaced bits DFR2(Sp,Dp:0) from the next phase, are used by the digital filter arithmometer3 (DFRA3) to fill end bits of the digital filter register3 (DFR3) with the correctly displaced bits propagated from the next phase to the present phase.

As it is shown in the FIG.1, FIG.2, FIG.3; all the timing and circuits for any further waveform processing can remain similar as shown in the PCT/CA03/000909 application with the differences based on increasing clock numbers by 3 starting from the Clk2; i.e. the 1Clk2 shall be replaced by the 1Clk5, and so on.

While the invention has been described with reference to particular example embodiments, further modifications and improvements which will occur to those skilled in the art, may be made within the purview of the appended claims, without departing from the scope of the invention in its broader aspect.

Numerous modification and variations of the present invention are possible in light of the above teachings. It is therefore to be understood that within the scope of the appended claims, the invention may be practiced otherwise than as specifically described herein.

What is claimed is:

1-22. (canceled)

23. A noise filtering edge detector (NFED) for recovering digital signal transitions and their phases from noisy waveforms while assuming ideal signal shape between the transitions, in order to identify digitally transmitted data, by continues over-sampling and digital filtering of the incoming waveform based on comparing an edge mask, representing an expected pattern of wave-form samples corresponding to an edge of the original wave-form, with a sequence of wave-form samples surrounding a consecutive analyzed sample; the NFED comprising:
a wave capturing circuit for capturing results of sampling the incoming wave-form in time instances produced by the outputs of the delay line which the sampling clock is propagated through;
a correlation calculating circuit for performing logical or arithmetic operations on particular samples of the edge mask and their counterparts from a wave samples region surrounding the consecutively analyzed sample of the captured wave-form, in order to calculate a correlation integral between the wave samples region and the edge mask;
a proximity estimating circuit for deciding if there is an edge occurrence at the consecutively analyzed sampling instant based on processing of such correlation integrals calculated for samples belonging to a surrounding wave region.

24. A noise filtering edge detector (NFED) for recovering digital signal transitions and their phases from noisy waveforms while assuming ideal signal shape between the transitions, in order to identify digitally transmitted data, by continues over-sampling and digital filtering of the incoming waveform based on comparing an edge mask, representing an expected pattern of wave-form samples corresponding to an edge of the original wave-form, with a sequence of wave-form samples surrounding a consecutive analyzed sample; the NFED comprising:
a wave capturing circuit, connected to a sampling clock and to the incoming waveform, for continues over-sampling of the incoming wave-form;
a correlation calculating circuit for performing logical or arithmetic operations on particular samples of the edge mask and their counterparts from a wave samples region surrounding the consecutively analyzed sample of the captured wave-form, in order to calculate a correlation integral between the wave samples region and the edge mask;
a proximity estimating circuit for deciding if there is an edge occurrence at the consecutively analyzed sampling instant based on processing of such correlation integrals calculated for samples belonging to a surrounding wave region.

25. An edge detecting filter (EDF) for recovering data carrying edges from a noisy received signal by dense over-sampling of the received signal and by detecting edge phases and edge amplitude limits wherein recovered signal amplitudes at sampling instance defining said edge phase are determined by said edge amplitude limits while recovered amplitudes assumed at sampling instances following the last edge detected are those implementing an ideal signal shape determined by the last edge; the edge detecting filter comprising:
a wave capturing circuit for such over-sampling of the received signal and for capturing a wave-form sampled;
a wave-form processor estimating correlations between a set of wave-form samples surrounding an analyzed consecutive sample and their counterparts from an edge mask, and for combining such estimates of individual bits correlations into a correlation integral characterizing level of similarity between the surrounding set of samples and the edge mask;
the wave-form processor analyzing such correlation integrals in order to decide if there is an edge at the analyzed consecutive sample and to detect edge phase and edge amplitude limits if said edge does occur.

26. An EDF as claimed in claim 25, wherein the waveform processor comprises:
parallel processors for simultaneous calculation of correlation integrals for a multiplicity of waveform samples belonging a captured waveform interval in which said data carrying edge is expected.

27. An EDF as claimed in claim 25 using a method and system for synchronous sequential processing (SSP), which multiplies processing speed by splitting complex signal processing operation into a sequence of singular micro-cycles, for implementing the functions of the wave capturing circuit and the waveform processor; wherein the SSP comprises:
multiple serially connected sequential stages clocked by reference sub-clocks generated by a reference propagation circuit built with serially connected gates which a reference clock is propagated through, wherein every such serially connected stage is designated to perform a basic logical or arithmetical operation during such consecutive singular micro-cycle of the complex operation;
a configuration of parallel processing stages of the received signal, wherein multiple processing stages are driven by the same sub-clock which is applied simultaneously to inputs of output registers of all the parallel stages.

28. An EDF as claimed in claim 25 further including adaptive noise filtering using a programmable control unit (PCU) for an adaptive compensation of the received signal noise by analyzing selected intervals of the captured waveform and by modifying said edge masks and/or by reprogramming functions performed by said waveform processor; the EDF further comprising:
a waveform screening and capturing circuit (WFSC) for accessing and buffering of pre-selected intervals of said captured waveform;
the programmable control unit for said analysis of noise and/or distortions occurring in said pre-selected intervals; and for implementing adaptive noise compensation algorithms by said modifications of the edge masks and/or by said reprogramming of the waveform processor.

29. An edge detecting filter (EDF) for recovering data carrying edges from a noisy received signal by dense over-sampling of the received signal and by detecting edge phases and edge amplitude limits wherein recovered signal amplitudes at sampling instance defining said edge phase are determined by said edge amplitude limits while recovered amplitudes assumed at sampling instances following the last edge detected are those implementing an ideal signal shape determined by the last edge; the edge detecting filter comprising:
a wave capturing circuit for such over-sampling of the received signal and for capturing a wave-form sampled;
a wave-form processor estimating correlations between a set of wave-form samples surrounding an analyzed consecutive sample and their counterparts from an edge mask, and for combining such estimates of individual bits correlations into a correlation integral characterizing level of similarity between the surrounding set of samples and the edge mask;
the wave-form processor analyzing such correlation integrals in order to decide if there is an edge at the analyzed consecutive sample and to detect edge phase and edge amplitude limits if said edge does occur, wherein said analysis includes finding an extreme of said correlation integrals in a waveform area expected to comprise a valid data carrying edge wherein such sampling instant which has such extreme correlation integral defines the edge phase recovered and the edge mask used defines the edge amplitude limits.

30. A method for edge noise filtering (EFM) using time domain processing for recovering phases and amplitude ranges of data carrying edges from a noisy received signal while amplitudes occurring between the recovered edges are assumed to equal those implementing a known ideal signal shape determined by the last recovered edge, instead of spending processing resources on calculating every recovered amplitude and recovering data carrying edges from such incomplete amplitude oriented results deprived already of relevant phase/time related information; the method for edge noise filtering comprising the steps of:
dense over-sampling of the received signal and capturing resulting over-sampled waveform;
recovery of said phases and amplitude ranges of data carrying edges by time domain processing of the over-sampled waveform;
recovery of data transmitted from the phases and amplitude ranges of recovered edges;
or recovery of an entire signal transmitted originally by defining it's amplitudes as equal to those defined by said amplitude ranges at sampling instances defining said edge phases, and by defining it's amplitudes as equal to those implementing known ideal signal shape determined by the last recovered edge at sampling instances located between the last and next edges.
